(19) United States
(12) Patent Application Publication
(10) Pub. No.: US 2008/0265576 A1
(43) Pub. Date: Oct. 30, 2008

(54) DEVICES FOR TEACHING OR AIDING IN THE MAKING OF KNOTS AND METHODS FOR MAKING AND USING THEM

(75) Inventors: Karen MAY-NEWMAN, San Diego, CA (US); Peter NEWMAN, San Diego, CA (US); Edward BEAIL, San Diego, CA (US); Meral DEMIR, San Diego, CA (US)

Correspondence Address: MORRISON & FOERSTER LLP, 12531 HIGH BLUFF DRIVE, SUITE 100, SAN DIEGO, CA, 92130-2040, US

(73) Assignee: San Diego State University Research Foundation, San Diego, CA (US)

(21) Appl. No.: 12/015,900

(22) Filed: Jan. 17, 2008

Related U.S. Application Data
(60) Provisional application No. 60/885,381, filed on Jan. 17, 2007.

(51) Int. Cl. B65H 69/00; G09B 21/00

(52) U.S. Cl. 289/1.5; 434/112; 289/2; 289/17

(57) ABSTRACT

This invention provides a device, or product of manufacture, for use as a teaching device for tying knots, or as an aid in tying knots, e.g., as for use by handicapped or disabled individuals. The invention provides device, or product of manufacture, completely automated for tying knots using the device and/or methods of the invention. The invention also provides methods for making and using these devices of the invention.

This application claims the benefit of priority under 35 U.S.C. § 119(e) of U.S. Provisional Application No. 60/885,381 filed on Jan. 17, 2007. The contents of this document are incorporated herein by reference.

### STATEMENT OF RIGHTS TO INVENTIONS MADE UNDER FEDERALLY SPONSORED RESEARCH

This work was funded by NSF Grant #0314095, “ Undergraduate Design Projects for Developing Assistive Technology for Recreational Applications” within the program for Rehabilitation to Aid Persons with Disabilities (RAPD). The United States government may have certain rights in this invention.

### FIELD OF THE INVENTION

This invention provides device, apparatus, or products of manufacture, for use as a teaching device for tying knots, or as an aid in tying knots, e.g., as for use by handicapped individuals. The invention also provides methods for making and using these devices of the invention.

### BACKGROUND

Knot tying aboard a sailboat can be difficult for any sailor. Sailors with various upper extremity disabilities can find knot tying next to impossible. By understanding the full impact of an upper extremity disability and its corresponding loss of manual dexterity one can begin to understand what is required of a person with a disability while tying a knot.

### SUMMARY

The invention provides devices, or products of manufacture, for use as a teaching device for tying knots, or as an aid in tying knots, e.g., as for use by handicapped, disabled individuals, or individuals in rehabilitation, e.g., because of disease or conditions (e.g., arthritis) or injury. The invention also provides methods for making and using these devices of the invention.

In one aspect, a device of the invention assists a person with limited finger dexterity to tie a knot, e.g., a bowline knot.

In one aspect, a device, apparatus or product of manufacture comprises, or alternatively consists of, a baseplate with a hole pattern drilled to allow the placement of (at least) four risers. A cam cleat is mounted to each riser for gripping the rope (or equivalent, e.g., a thread, wire, string, etc.). The cam cleat/risers are placed in an orientation and pattern that positions and secures the rope correctly during the tying task. The user places the rope into the cam cleats following a set of directions (rabbit-in-the-hole analogy) and the knot “pops” out of the cleats when completed.

In one aspect, a device, apparatus or product of manufacture of the invention is used to assist in tying knots, or as a teaching aide in tying knots, e.g., as tying a knot on a sailboat, or for any other variety of uses including but not limited to:
Teaching anyone how to tie a knot—as a general instructional tool for children, adults, the handicapped (including disabled, amputees, the blind, or learning disabled), or as an aide in manual dexterity improvement in general;
In one aspect, a smaller version is adapted to help children learn to tie knots, e.g., their shoes, or as an aide in manual dexterity improvement in general;
In one aspect, an embodiment of the device is used for tying a gift bow, e.g., in a commercial context, or as in an automated device;
In alternative aspects, embodiments of the device are used in any application where an individual with either limited dexterity or limited knowledge is trying to tie a knot or bow.

The details of one or more embodiments of the invention are set forth in the accompanying drawings and the description set forth herein. Other features, objects, and advantages of the invention will be apparent from the description and drawings, and from the claims.

All publications, patents, patent applications cited herein are hereby expressly incorporated by reference for all purposes.

### BRIEF DESCRIPTION OF DRAWINGS

The following drawings are illustrative of aspects of the invention and are not meant to limit the scope of the invention as encompassed by the claims.

FIG. 1 is an illustration of an exemplary device of the invention, an exemplary methods and device to tie a bowline knot.

Like reference symbols in the various drawings indicate like elements.

### DETAILED DESCRIPTION

In one aspect, the invention provides devices, apparatus or products of manufacture, for use as a teaching device for tying knots, or as an aid in tying knots, e.g., as for use by handicapped individuals (including disabled, amputees, the blind, or learning disabled), or as an aide in manual dexterity improvement in general. The invention also provides methods for making and using these devices of the invention.

In one aspect, the invention provides devices, or product of manufactures, and methods for using them, encompassing a hand-held board with cleats attached to one side can be used to hold a rope (or equivalent, e.g., a thread, wire, string, etc.) in position while tying a knot. The cleats can be positioned on the board in different arrangements to best facilitate a particular type of knot. This is designed for individuals with limited dexterity; and can be used for any application, e.g., for sailing applications, or for teaching the general concept of dexterity, e.g., as a physical therapy method.

In one aspect, the invention provides devices, or product of manufactures, and methods for using them, for assisting people with limited hand mobility to tie knots. In one aspect, the devices, or product of manufactures, comprise, or consist of, a board with cleats placed in a pattern that enables easy tying of a bowline and other knots. In one aspect, it is designed for use on sailboats. In one aspect, it is designed for use as a physical therapy device. In one aspect, it is designed for teaching children.

A number of aspects of the invention have been described. Nevertheless, it will be understood that various modifications may be made without departing from the spirit and scope of the invention. Accordingly, other aspects are within the scope of the following claims.

What is claimed is:

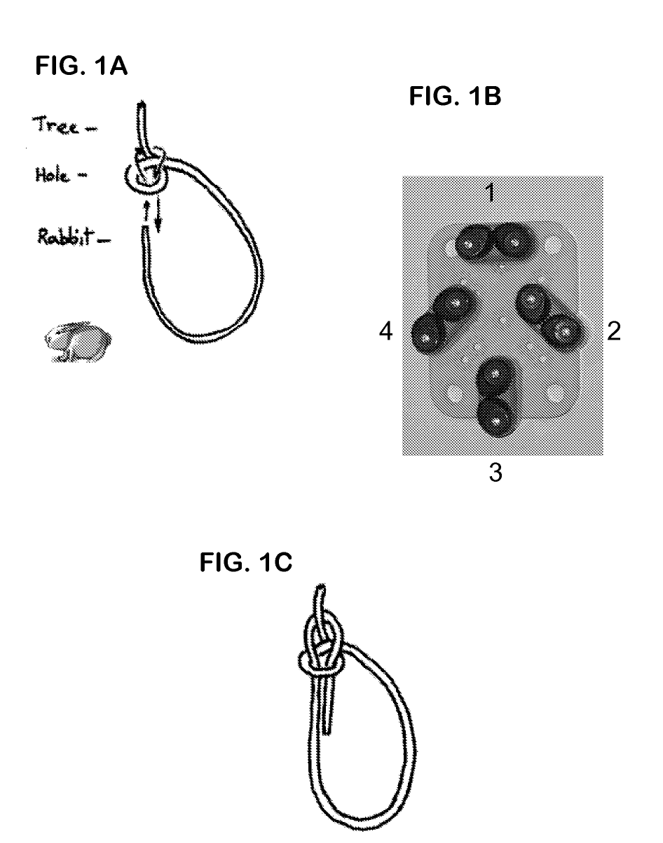

1. A device, or product of manufacture, as set forth in FIG. 1.

2. A method for teaching, or instructing, how to tie a knot, comprising instructions for using the device, or product of manufacture, as set forth in FIG. 1.

3. An automated device, or product of manufacture, comprising an automated version of a device, or product of manufacture, as set forth in FIG. 1.
